(19) United States
(12) Patent Application Publication
(10) Pub. No.: US 2008/0111655 A1
(43) Pub. Date: May 15, 2008

(54) Magnetic flotation device

(76) Inventors: John Michael Wozniak, New Buffalo, MI (US); John Alexander Wozniak, Houston, TX (US)

Correspondence Address: J.M. WOZNIAK, JR., P.O. BOX 356, NEW BUFFALO, MI, 49117, US

(21) Appl. No.: 11/599,908

(22) Filed: Nov. 15, 2006

(51) Int. Cl. H01F 7/00

(52) U.S. Cl. 335/216

(57) ABSTRACT

This disclosure discusses a means of generating a magnetic field around a device such that it can interact with the geomagnetic field of the earth in such a manner to develop a net lift against the pull of gravity. A flow of electric current is directed in a manner that exposes only a part of the magnetic field while the balance is sequestered within the device and shielded from exposure to the geomagnetic field. Hence an object can be lifted off the surface of the earth by electromagnetic means alone without the need for interacting with the atmosphere, as in airplanes, or the need for the expulsion of material as in chemical rockets. The magnetic flotation device can be likened to a gas-filled balloon except that the buoyancy is provided by the interaction of magnetic fields, not gas density.

### CROSS-REFERENCE RELATED APPLICATIONS

Not applicable

### STATEMENT REGARDING FEDERALLY SPONSORED R OR D

### Not applicable

### REFERENCE FOR SEQUENCE LISTING, . . .

Not Applicable

### BACKGROUND OF THE INVENTION

Today, as in the past 5-6 decades, we lift an object into space through the use of chemical rockets. The tons of material ejected from the rocket nozzle is used primarily to move the object out of the gravity well of the earth and, secondarily to achieve a velocity vector as needed to maintain an orbit at the desired altitude. If we can lift the object above the majority of the atmosphere without using a chemical rocket, tons of material can be saved and the cost per pound in orbit would drop dramatically.

Robert M, Zubrin, in an article titled “The Magnetic Sail”, (Analog Science Fiction & Fact, May, 1992) detailed how a spacecraft could be lifted from the surface of the earth using a 64 km diameter superconductive loop. Though mathematically possible, not currently practical.

Frederic B. Jueneman, in an article titled “On UFO Propulsion” (R & D Magazine, December, 1993) speculated on an “enhanced diamagnetic drive” perhaps involved with “superconductivity” which may power a spacecraft. Certainly food for thought but nothing currently practical.

Currently, a company called JP Aerospace (Rancho Cordova, Calif. 95742) is engineering a group of gas-filled balloon-type vehicles to transport objects to a transfer point of 140,000 feet and thence into space. This would be a three step process requiring a transfer of men and materials at that altitude. A special propeller driven craft would ascend from earth to the transfer station and the cargo would be transferred to a second vehicle which would use ion propulsion to achieve orbit.

All of these means suffer from various limitations.
Chemical Rockets: High cost per pound to put an object into space; pollution of the atmosphere; working with large volumes of explosive materials.
Magnetic Sail: Current impracticality of the large superconductive loop; can only be launched near the geomagnetic poles where the field is near vertical.
UFO Propulsion: Still only speculation.
JP Aerospace: Requires three steps to orbit using three different platforms with cargo transfers between steps 1 & 2 and 2 & 3.

### BRIEF SUMMARY OF THE INVENTION

The invention depends upon an interaction that science has known of since the 1800's and that is a current-carrying conductor can be deflected by a magnetic field. All of our AC & DC motors operate on this principle. Our invention consists of a unique means of using the conductor arrangement to sequester part of the magnetic field from exposure to the geomagnetic field and producing a sufficiently strong magnetic field to produce a useable and controlled interaction with the geomagnetic field. The force generated (the lift) is essentially the product of the geomagnetic field and the field surrounding the magnetic flotation device.

The invention in its spacecraft mode would use a multiplicity of superconductive elements in which a current would be generated on the ground using preferably a ground-based current source while maintaining the superconductors at the required temperature. While the longitudinal dimension of the superconductors is parallel to the geomagnetic field, lift is negligible. When the craft is rotated such that the longitudinal dimension is perpendicular to the geomagnetic field, the craft will launch. The acceleration will depend upon the excess of lift to the mass being lifted. Adjustments to the lift can be made by adjusting the angle between the longitudinal dimension of the superconductors and the geomagnetic field.

The advantages of this invention are: does not use chemical rockets to escape the gravity well; does not require long, unwieldy superconductive current loops; provides a true single stage to orbit; once the current is generated in the element, it will continue as long as the correct temperature is maintained so the required lift energy does not need frequent replenishment; the design of the superconductive elements are such as to shield the human passengers from the high magnetic field and from solar storms.

### BRIEF DESCRIPTION OF THE SEVERAL VIEWS OF THE DRAWINGS

FIG. 1 depicts an external view of one magnetic flotation device, herein referred to as MFD element.

FIG. 2 is a longitudinal sectional view of an MFD.

FIG. 3 is a cross-sectional view of an MFD.

FIG. 4 is a schematic view of an MFD showing the electric circuit.

FIG. 5 shows the MFD within the geomagnetic field.

FIG. 6 illustrating the angle of the MFD to the geomagnetic field.

FIG. 7 demonstrates MFD's connected in electrically in series.

FIG. 8 is a schematic view of a typical spacecraft.

FIG. 9 is a sectional view of the typical spacecraft.

FIG. 20 illustrates the concentric rows of MFD's within a lifting nacelle.

### DETAILED DESCRIPTION OF THE INVENTION

FIG. 1 illustrates an essentially tubular device which we call a magnetic flotation device 1 and referred to in the following as an MFD element. MFD elements may be used singly or in multiple. The outer shell of 1 is coated with preferably a high temperature superconductive ceramic, such as Yttrium barium copper oxide. Contact conductivity is improved at 30 by the addition of silver to the mix. An insulating gap 20 is provided at between the contact points 30.

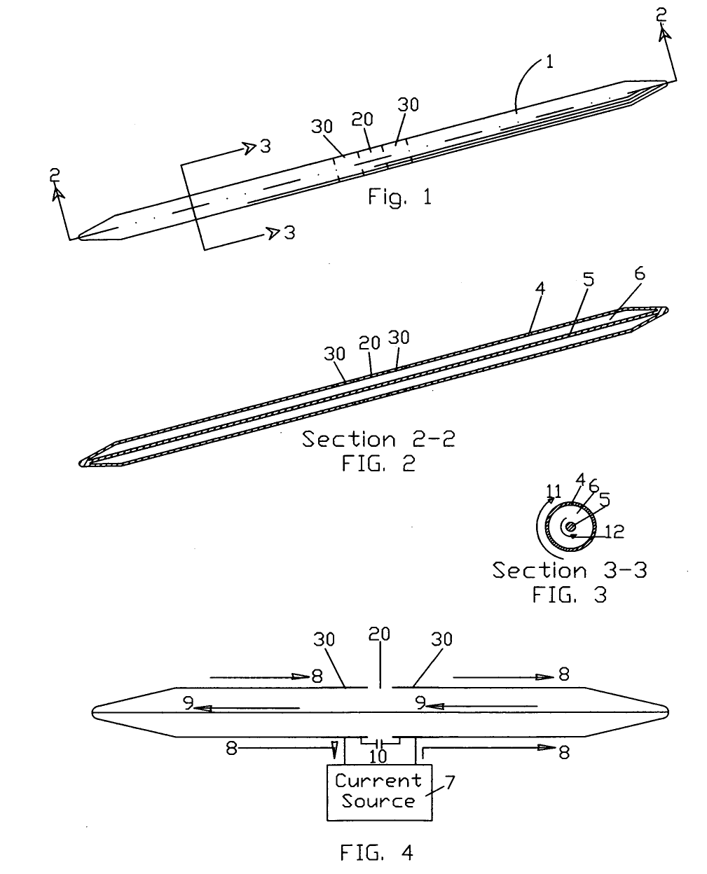

The sectional view in FIG.2 shows that the MFD is basically a insulating rod 6 with a superconductor filament 5 through the center and a superconductor coating 4 on the surface. Note that at the ends, the inner filament 5 is electrically connected to the outer coating 4. Insulating gap 20 is circumferential between contact points 30.

FIG. 4 shows a schematic view of the MFD element when connected to a current source 7. It is assumed that the MFD resides in an ambient temperature that maintains it at or below at its critical temperature. The current source 7 is connected to the MFD 1 at contact points 30. Since the gap 20 is insulating, the current flow 8 proceeds through the outer coating 4 to the inner filament 5 and thence along path 9 and back to the outer coating 4 returning to the current source 7. When the proper flow of current id achieved, the superconductive shunt 10 is closed and the current source is removed from that MFD element. With the MFD element being maintained at or below its critical temperature, the current will continue to flow without loss.

FIG. 3 a cross-section of the MFD 1 shows the result of the aforementioned current flow. Filament 6 shows a counter-clockwise direction of magnetic flux 12 within the insulating rod 6 whereas the coating 4 shows a clock-wise flux 11. It is important to note that magnetic flux 12 is shielded from interaction with any magnetic field external to the coating 4. Note also that filament 5 though shown as solid may also be hollow, in this case, tubular in section.

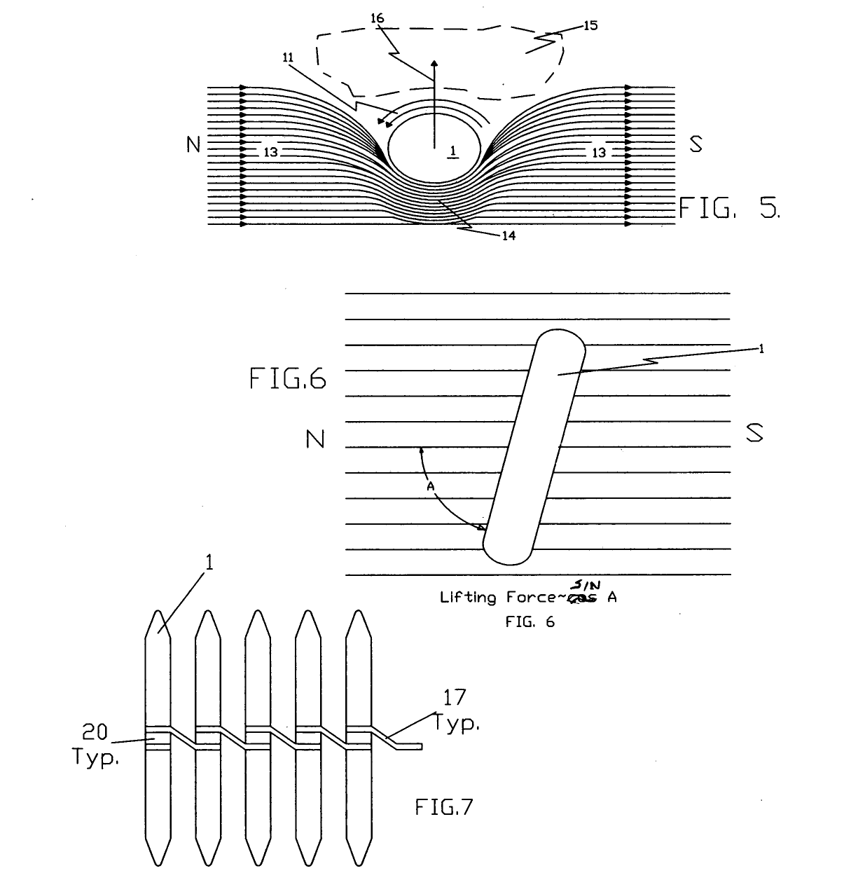

FIG. 5 illustrates the interaction of the magnetic field 11 of the MFD 1 with the geomagnetic field of the earth 13. Flux 11 forces the geomagnetic field 13 below MFD 1 creating a maximum field density at 14 and a minimum field density at 15. This creates a net force on MFD 1 in the direction of vector 16 thus creating lift. The force created is essentially the product of the geomagnetic flux density and the MFD flux density. Since the geomagnetic field is relatively weak, a large flux must be created by the MFD to provide practical lift. FIG. 6 shows that the longitudinal axis of MFD 1 can form an angle A with the geomagnetic field. The lifting force will be proportional to the sine of the angle A. Since force is equal to mass times acceleration the acceleration along vector 16 by setting the force greater than the mass and adjusting angle A to set the acceleration.

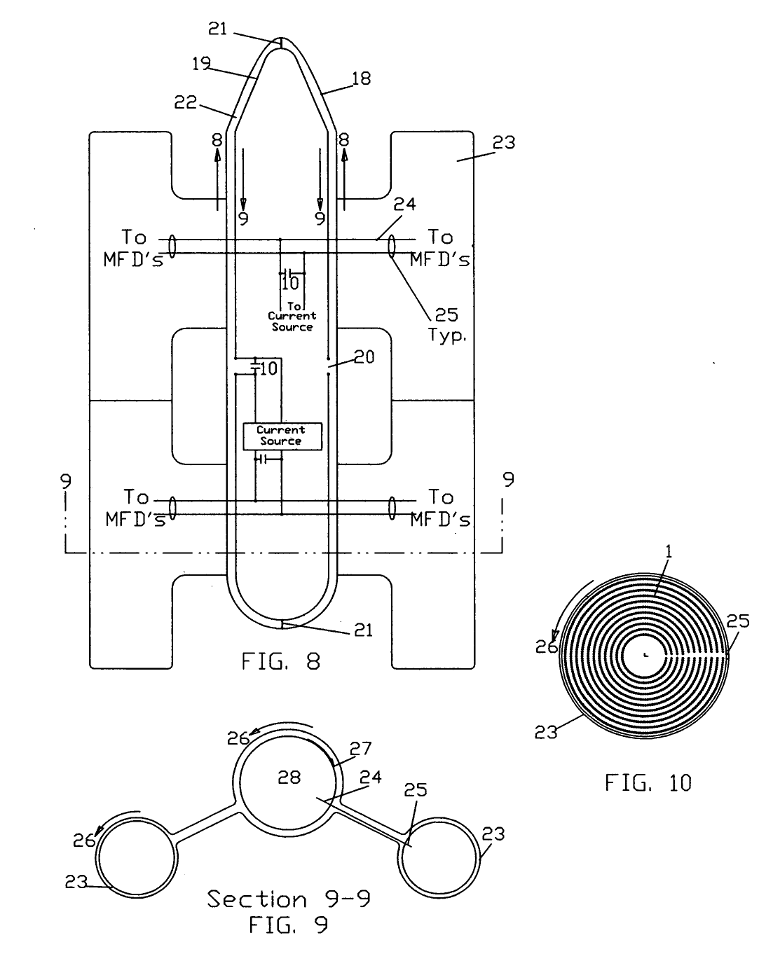

FIG. 7 shows multiples of MFD 1 that are electrically connected through superconductors 17. Since the superconductors are essentially resistanceless, many MFD may be connected in series to simplify the charging with the current source. This is further illustrated in FIG. 8 and FIG. 10.

FIG. 8 is a schematic illustration of a spacecraft consisting of the fuselage shell 18 which is superconductive, interior lining 19 which is also superconductive connected at their ends with superconductive shorts 21. Attached to the fuselage are lifting nacelles 23 containing a multiplicity of MFD'd in concentric rings within a cassette as shown in FIG. 10. The current source 7 along with superconductors 24 and shunts 10 allow a relatively small current source to charge a large group of MFD sequentially. This will be evident to anyone skilled in power distribution and control. Note that current source 7 can drive current through the interior lining 19 which is separated by gap 20 so that the current flows through the end shorts 21 thence through the exterior shell 18, returning to the current source 7 through short 21 and interior lining 19. Current flow direction is indicated by 8 on the exterior and 9 on the interior. FIG. 9 shows that flux direction 26 is created outside the fuselage and flux 27 is created within the space between shell 18 and interior lining 19. The interior space 28 is essentially flux free shielding human operators not only from the craft generated flux but also form fast moving protons and electrons that may come with a solar storm or gamma rays. The intent here is not to engineer a spacecraft but only to show what is possible with this invention and its ramifications.

Chase 25 provides for superconductors to pass to the MFD cassettes. Though four Lifting nacelles are shown it will be obvious to those skilled in the art that these elements of design depend upon the mass of the load that needs to be lifted, the sizing and charging of the MFD elements and the capacity and weight of the onboard current source. Note also that the MFD cassettes can be charged initially by a ground power source. Not shown but needed for practicality is an on board refrigerator system to maintain the superconductors at or below their critical temperature. Since interplanetary temperature is about 2.7K little refrigeration will be required but reflective shielding to minimize solar heating will be required.

A tubular shape for the MFD is the most efficient but other cross-sections can be used. Again, though high temperature superconductors are to be preferred because of their use of nitrogen for cooling which is readily available, relatively inexpensive, non-explosive and easy to handle, other superconductive materials and other cooling fluids can be used. The newer Magnesium diboride superconductor material using Neon fluid as a coolant may perform as well.

What we claim as our invention is:

1. A geometric means of arranging a circuit of superconductive material with an interior solid filament and exterior shell and connecting them in such a manner that the magnetic field around the interior filament is shielded by the exterior superconductor and the exterior magnetic field allowing a net magnetic field to interact with exterior magnetic fields.

2. A geometric means of arranging a circuit of superconductive material as in claim 1 above, but where the interior filament is hollow in cross-section thence becoming a tube having the same advantages and in addition providing a magnetic flux-free environment within the hollow of the interior tube and providing protection against high speed protons, electrons and ions.

3. The same geometric arrangement as in claims 1 and 2 but using metallic conductors or semiconductor in place of or in addition to superconductors.
